(19) United States
(12) Patent Application Publication
(10) Pub. No.: US 2011/0309596 A1
(43) Pub. Date: Dec. 22, 2011

(54) Arm powered cycle/vehicle for paraplegics

(76) Inventors: David William Holmes, Nottingham (GB); Paul Leslie Bruce Wright, Nottingham (GB)

(21) Appl. No.: 13/158,707

(22) Filed: Jun. 13, 2011

(30) Foreign Application Priority Data
Jun. 16, 2010 (GB) GB1010094.9

(51) Int. Cl. B62M 1/16; F16H 19/02; F16H 19/06

(52) U.S. Cl. 280/246; 74/37; 74/25

(57) ABSTRACT

The proposed invention is a human powered cycle/vehicle which utilizes a reciprocating arcuate linear handlebar motion to operate a double acting asynchronous propulsion mechanism which imparts constantly proportional input versus output motion to its' surface engaging propulsion wheel(s). The propulsion mechanism contains a complex mechanism which causes both backward and forward motions of a set of handlebars to propel the machine forward. A drive-train clutch (52) may be included which enables the propulsion mechanism to be disengaged thus allowing the cycle/vehicle to be reversed and or moved (pushed) in either direction via its' surface engaging wheel(s) in isolation to the propulsion mechanism. A steering mechanism may also be attached to the handlebars (1) which are rotated clockwise to steer the machine to the right and anti-clockwise to steer the machine to the left.

### CROSS REFERENCE TO RELATED APPLICATIONS

This application claims priority from United Kingdom patent application No: GB1010094.9 filed on the 16 of Jun. 2010.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to cycles/vehicles having two or more wheels which are operated by hand(s)/arm(s) or an attachment thereto; to be used by able or less able bodied people, but especially by paraplegics, amputees and people wishing to develop upper body strength.

In the field of hand powered cycles/vehicles, many types of propulsion mechanisms have been proposed/adopted, ranging from the cyclic motion of the “crank” mechanism (as in the ordinary pedal cycle), to reciprocating arcuate motion lever types which use either twin levers, one per hand, or a single lever operated by a set of handlebars. Both latter types may be single or double acting; double acting types propelling the machine on both forward and backward strokes. These latter types (reciprocating lever) offer some considerable advantages over cyclic propulsion (as in the “hand-cycle” crank mechanism), both in terms of efficient use of hand motions (a person generally has more power available in push/pull than up/down movements) and the ability to incorporate a very user friendly steering motion. However, the drawback with double acting reciprocating lever types which utilize chain to drive twin ratcheting chain-wheels is, their drive chains are attached directly to their handlebar operated lever arm at some fixed point, which only imparts an efficient pull to the chain when the lever is at right angles to the chain line; as with designs which utilize the lever operated “crank” mechanism (as in the treadle of a sewing machine) which additionally require synchronous motion to operate them, and if stopped in the wrong place can be awkward to restart.

### BRIEF SUMMARY OF THE INVENTION

The proposed invention is a human powered cycle/vehicle with a propulsion mechanism which utilizes a double acting linear/arcuate reciprocal asynchronous hand(s) motion to propel it over a surface. A handlebar(s) is attached to a cranking lever which operates a twin ratcheting mechanism via a gear system, with said twin ratcheting mechanism subsequently applying a unidirectional driving motion to the cycle's/vehicle's surface engaging propulsion wheel(s) such that the relationship between input (handlebar movement) and output (propulsion wheel(s) rotation) is constantly proportional; thus avoiding the continuously varying hand speed required to operate prior art designs of twin ratcheting mechanism propelled cycles/vehicles. And it must be stated that although primarily intended for arm(s)/hand(s) operation, leg(s)/foot/feet operation of the cranking lever would be possible by exchanging the handlebar(s) for a suitable leg(s)/foot/feet harness. A drive-train clutch may be also be employed to enable disengagement of the propulsion mechanism from the cycle's/vehicle's surface engaging propulsion wheel(s) thus enabling the cycle/vehicle to be moved (pushed) over a surface via its' surface engaging wheels in either direction, independently from the propulsion mechanism. And a handlebar operated steering system utilizing a motion similar to that of a car steering wheel may easily be employed to operate the cycle's/vehicle's steerable wheel(s), with the advantage that the riders hands remain substantially equidistant from the their shoulders at all times.

### BRIEF DESCRIPTION OF THE SEVERAL VIEWS OF THE DRAWING

A three wheeled embodiment of the invention will now be described solely by way of example and with reference to the accompanying drawings in which:—

FIG. 1. a three dimensional view showing the general arrangement of a hand operated cycle/vehicle for paraplegics.

FIG. 2. a two dimensional side elevation of a hand operated cycle/vehicle for paraplegics showing the hand(s) motion used to propel it.

FIG. 3. a three dimensional view of the essentials of the constantly proportional double acting ratcheting propulsion mechanism which uses a continuous chain.

FIG. 4. a three dimensional view of variation number 1. of the double acting ratcheting propulsion mechanism which uses a discontinuous chain.

FIG. 5. a three dimensional view of variation number 2. of the double acting ratcheting propulsion mechanism which uses two front driving chain-wheels and a discontinuous chain.

FIG. 6. a three dimensional view of variation number 3. of the double acting ratcheting propulsion mechanism which uses a discontinuous chain tensioned by springs.

FIG. 7. a three dimensional view of variation number 4. of the double acting ratcheting propulsion mechanism which uses two front driving chain-wheels of similar or differing tooth numbers and dissimilar chain tensioning devices.

FIG. 8. a three dimensional view of variation number 5. of the double acting ratcheting propulsion mechanism which uses two front driving chain-wheels of similar or differing tooth numbers and two chains tensioned by bungee cord and jockey wheel.

FIG. 9. a three dimensional view of variation number 6. of the double acting ratcheting propulsion mechanism which uses a spur gear drive system.

FIG. 10. a three dimensional view of variation number 7. of the double acting ratcheting propulsion mechanism which uses a spur gear drive system to enable different hand pull/push gear ratios.

FIG. 11. a three dimensional view of variation number 8. of the double acting ratcheting propulsion mechanism which uses a bevel gear drive system.

FIG. 12. a three dimensional view of variation number 9. illustrating that any of the double acting ratcheting propulsion mechanisms may be remotely driven.

FIG. 13. a three dimensional view showing the general arrangement of the drive-train clutch and its' operating lever.

FIG. 14. a two dimensional view showing the side/end elevation of the clutch.

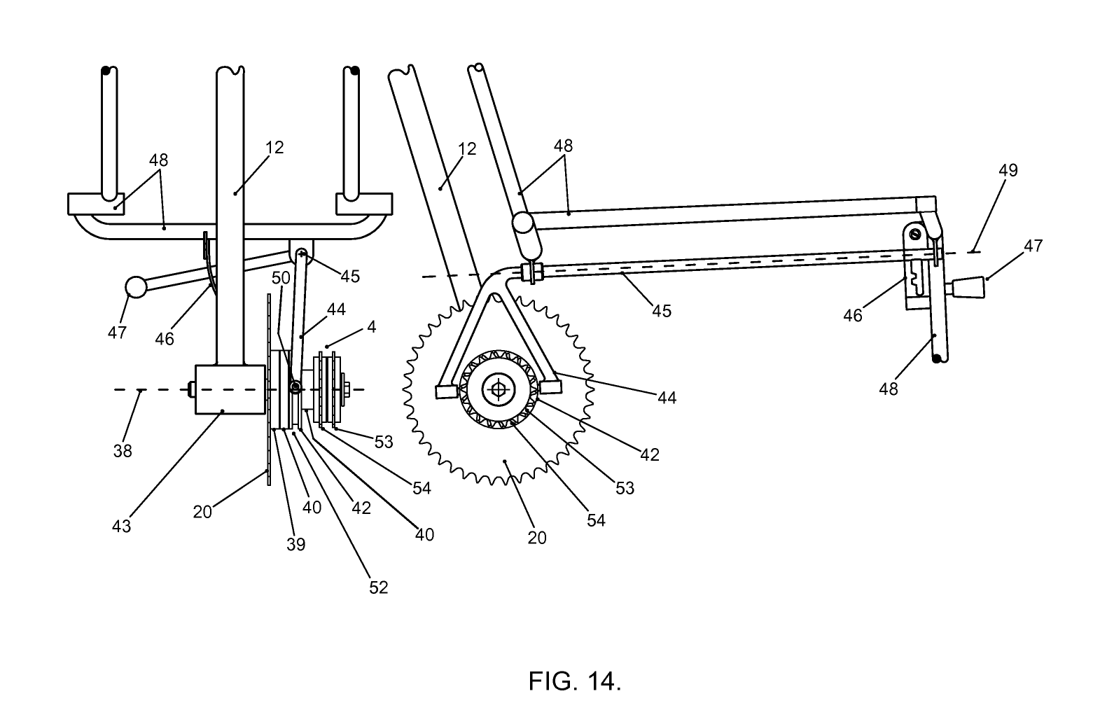

FIG. 15. a two dimensional exploded sectional view of the clutch along section line A-A.

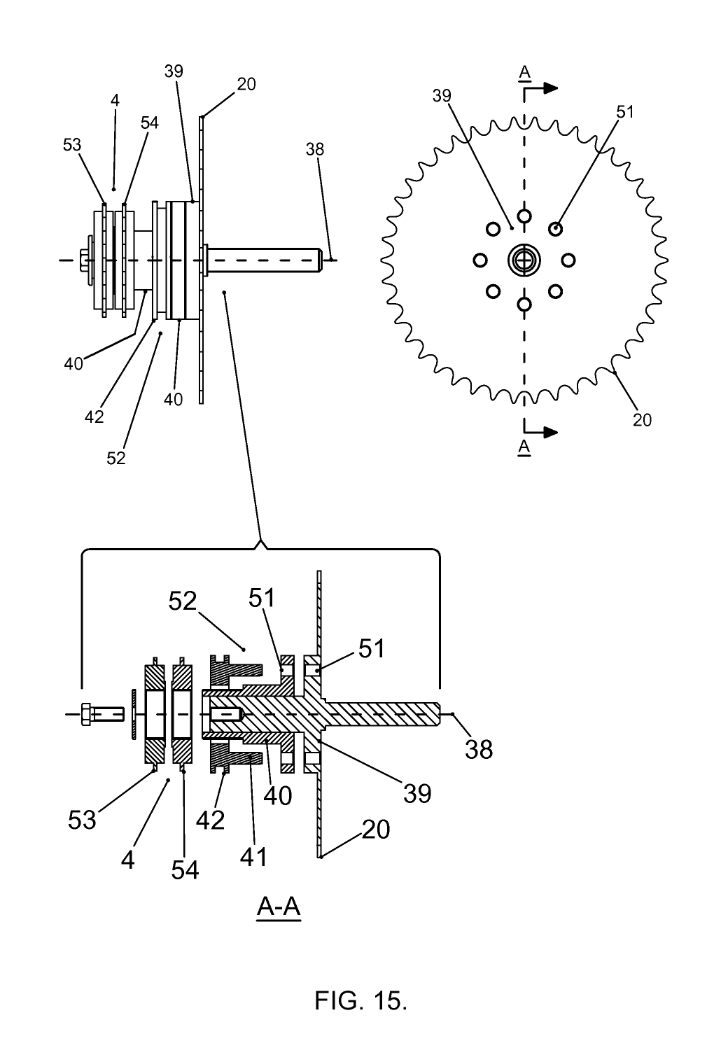

FIG. 16. a three dimensional view showing the handlebars complete with braking and gear changing controls, and attachment of handlebars to the steering mechanism bevel gears.

FIG. 17. a three dimensional view showing the axis of rotation of the handlebars, hidden detail of the steering torsion rod and how the steering mechanism universal/constant velocity joint operates co-axially with the front chain-wheel axis of rotation.

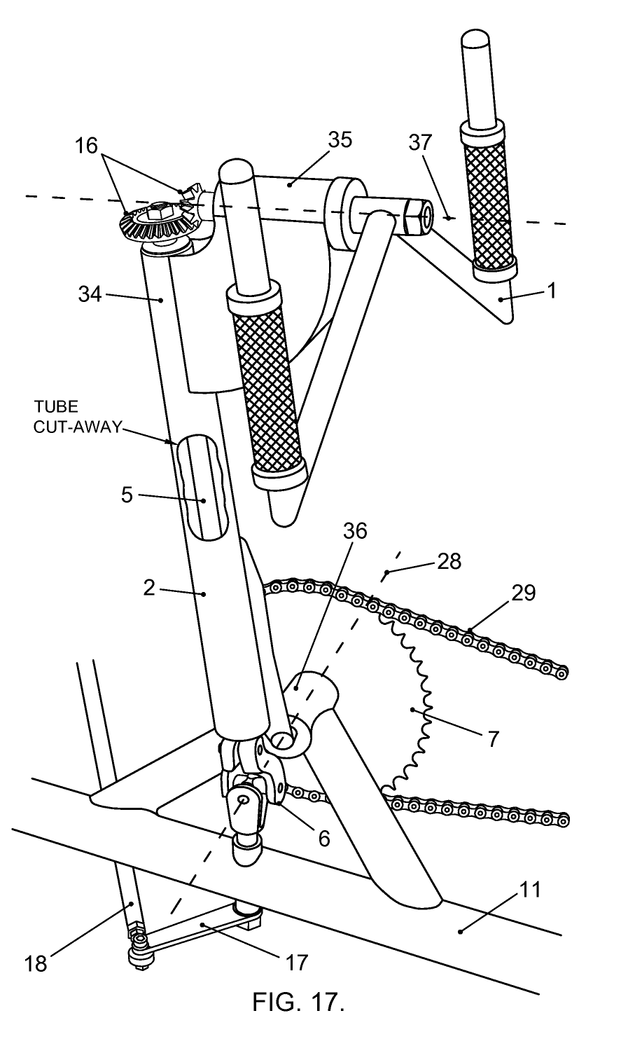

### DETAILED DESCRIPTION OF THE INVENTION A PREFERRED EMBODIMENT

### Chassis

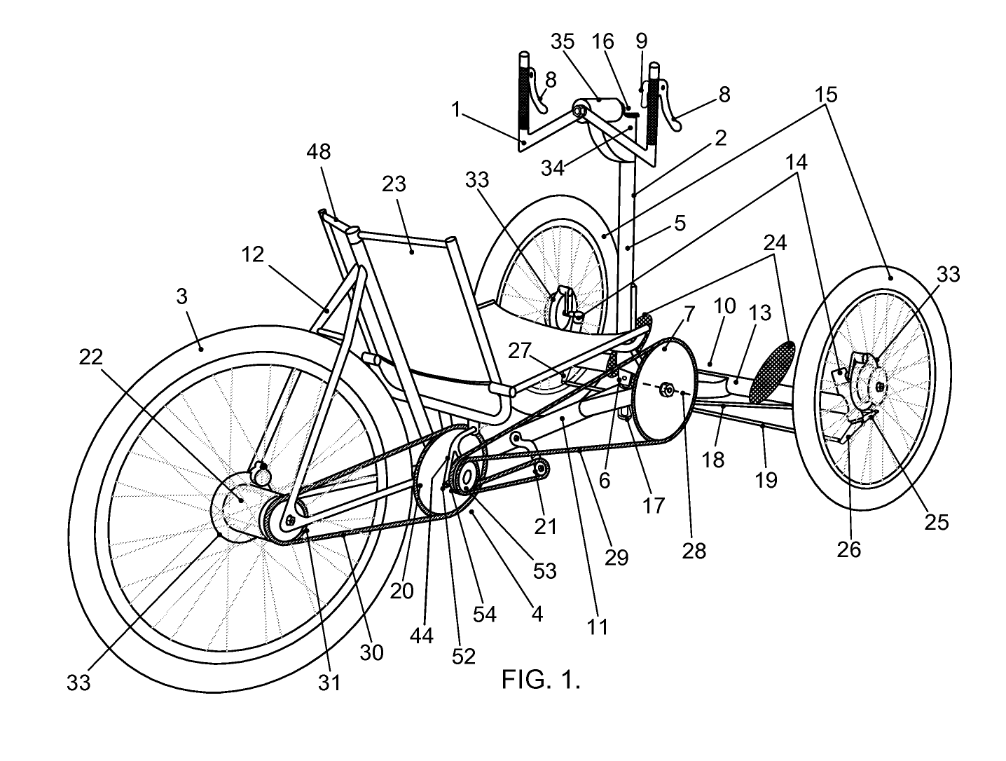

FIG. 1. The chassis (10) of the machine in this version is constructed of tubular metal and other resilient material and consists of a longitudinal member (11) which carries a triangulated fork (12) at its' rear end to which the surface engaging propulsion wheel (3) is attached. At the front end of the longitudinal member (11) is a crossbeam member (13) forming a “T” shape and carrying kingpins (14) on each end. The steerable front wheels (15) are attached to and revolve about the kingpins (14) to effect said steering.

### Propulsion

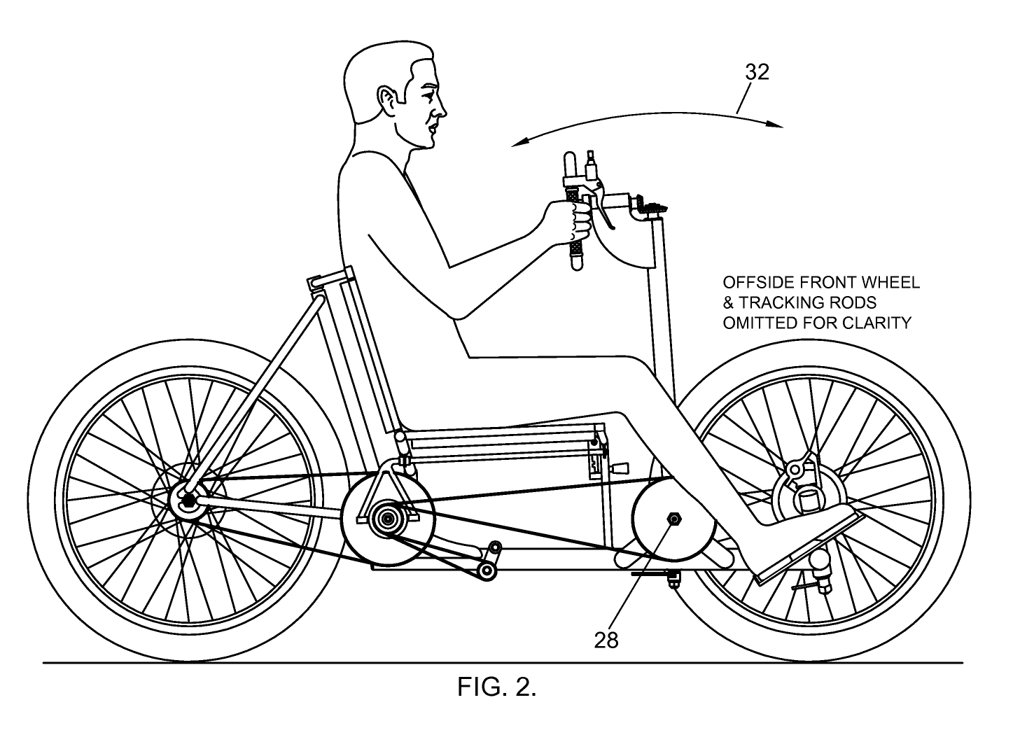

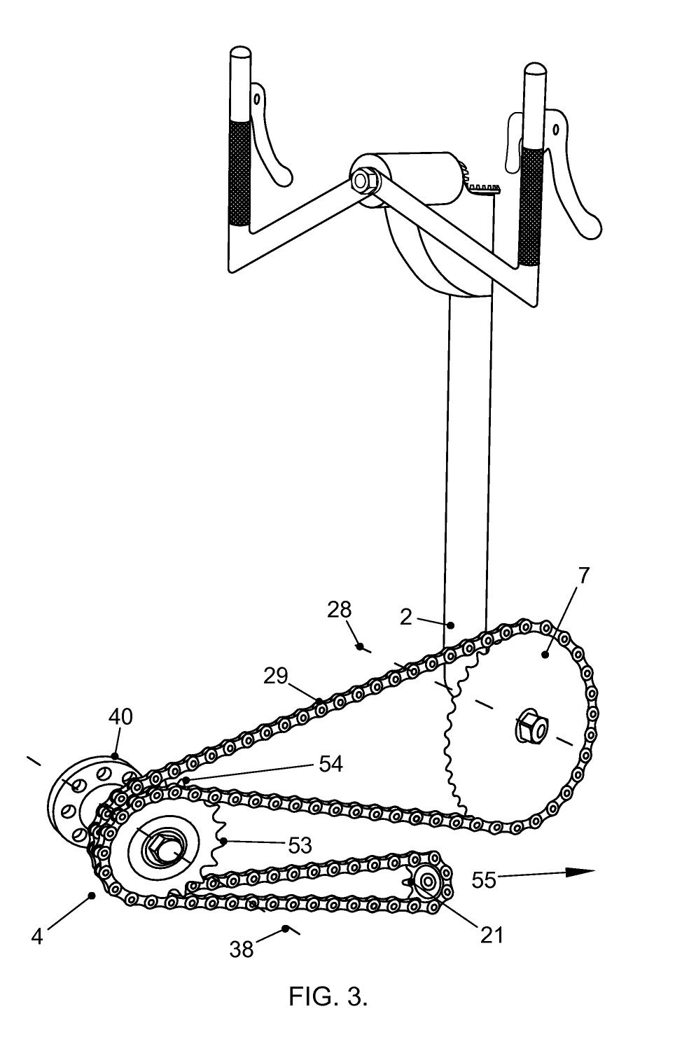

FIGS. 2. & 3. The cranking lever (2) takes the form of a tube which is attached to and acts upon a chain-wheel (7) to transmit force through the rest of the drive-train to the surface engaging propulsion wheel (3) whereby propulsion is obtained. In order to operate the cranking lever (2) the rider grasps the handlebars (1) which are attached to a bearing unit (35) mounted on top of the cranking lever (2) and works them back and forth (32) around the axis (28) of a bearing unit (36). Both backward and forward motions drive the machine forward. The mechanism (4) which allows this double action to take place consists of two ratcheting chain-wheels (53&54) mounted side by side on a shaft which turns the intermediate chain-wheel (20), both operating around the axis (38) of a bearing housing (43). Both top and bottom runs of the chain (29), which is driven by the front chain-wheel (7), run over the tops of the two ratcheting chain-wheels (53&54) and exit underneath to be tensioned in the general direction of arrow (55) by a fixed but adjustable (as in this embodiment) or a moving spring loaded, jockey wheel (21). A tensioner similar to that used in a cycle chain derailleur might be a sensible choice. Note. the chain (29) may be looped over the jockey wheel in either direction, i.e. the right hand run of the chain (29) may enter the jockey wheel from below and exit at the top as shown in FIG. 3., or vice versa. When a forward motion of the handlebars (1) is applied, the top run of the drive chain (29) turns the left hand ratcheting chain-wheel (54) forward which turns the intermediate chain-wheel (20) forward, while the bottom run of the chain (29) turns the right hand ratcheting chain-wheel (53) backward, which is free to spin on its' shaft without transmitting any force to the intermediate chain-wheel (20). When a backward motion of the handlebars (1) is applied, the lower run of the drive chain (29) turns the right hand ratcheting chain-wheel (53) forward which turns the intermediate chain-wheel (20) forward while the left hand ratcheting chain-wheel (54) is free to turn backward on its' ratchet. Thus while one ratcheting chain-wheel is driving the intermediate chain-wheel (20) forward the other recovers on its' ratchet. The intermediate chain-wheel (20) drives the surface engaging propulsion wheel (3) via a second chain (30) and rear chain-wheel (31), which is equipped with an internal hub gear (22) allowing various gear ratios to be selected by means of a lever operated mechanism (9) mounted on the handlebars (1).

### Propulsion Mechanism And Its' Variations

FIGS. 3. to 12. The variations show that any suitable gear system could be employed including synchronous/asynchronous belt(s), synchronous/asynchronous cord(s), pulley(s), gear-wheel(s), shaft(s), etc. As described below and detailed in FIGS. 3 to 11.

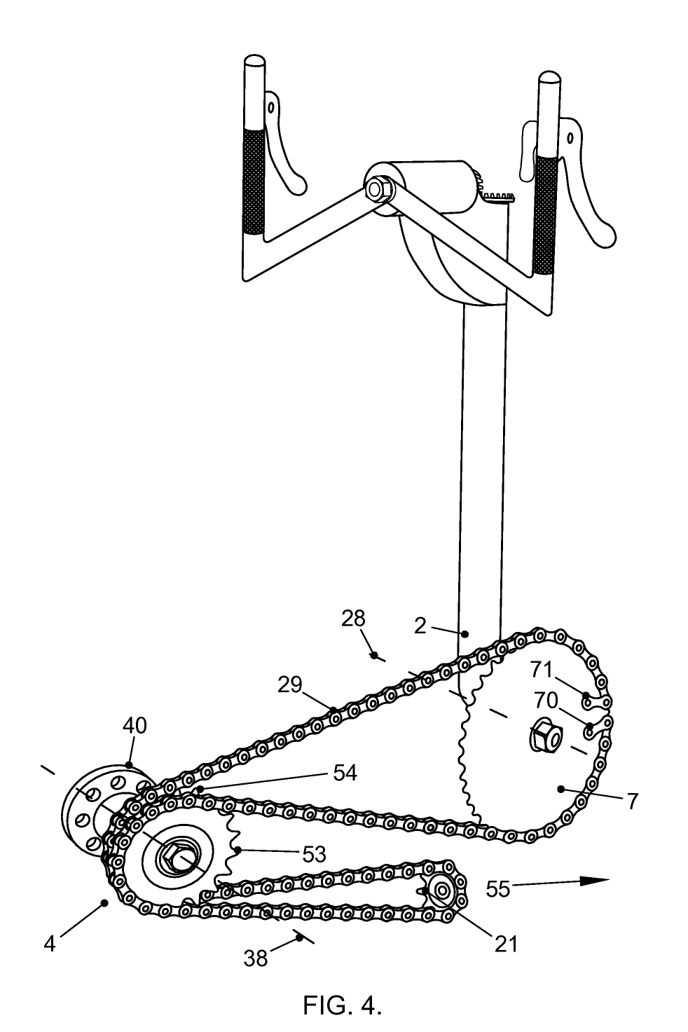

Variation 1). employs a discontinuous chain which is attached to the front chain-wheel (7) by spring links (70&71). Chain, belt or cord could be used for the flexible member by employing a suitable method of attachment to the front round driving member. See FIG. 4.

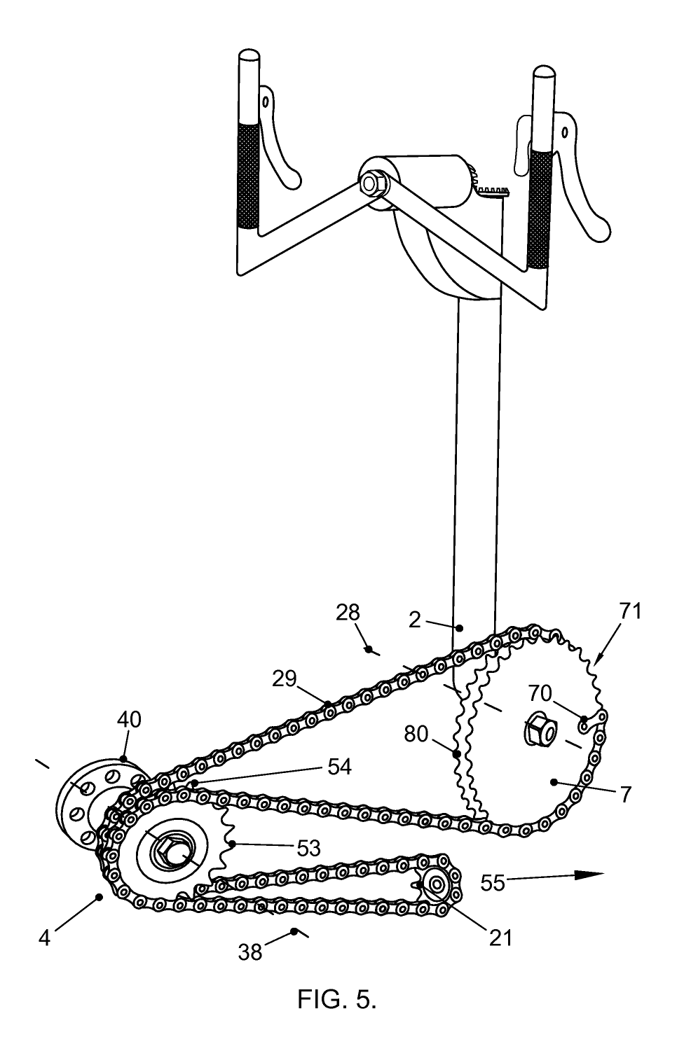

Variation 2). employs dual side by side chain-wheels (7&80) with the drive chain (29) rendered discontinuous and attached to each chain-wheel (7&80) by spring links (70&71). This enables better drive chain alignment runs to each ratcheting chain-wheel (53&54). Chain, belt or cord could be used for the flexible member by employing a suitable method of attachment to the front round driving member. See FIG. 5.

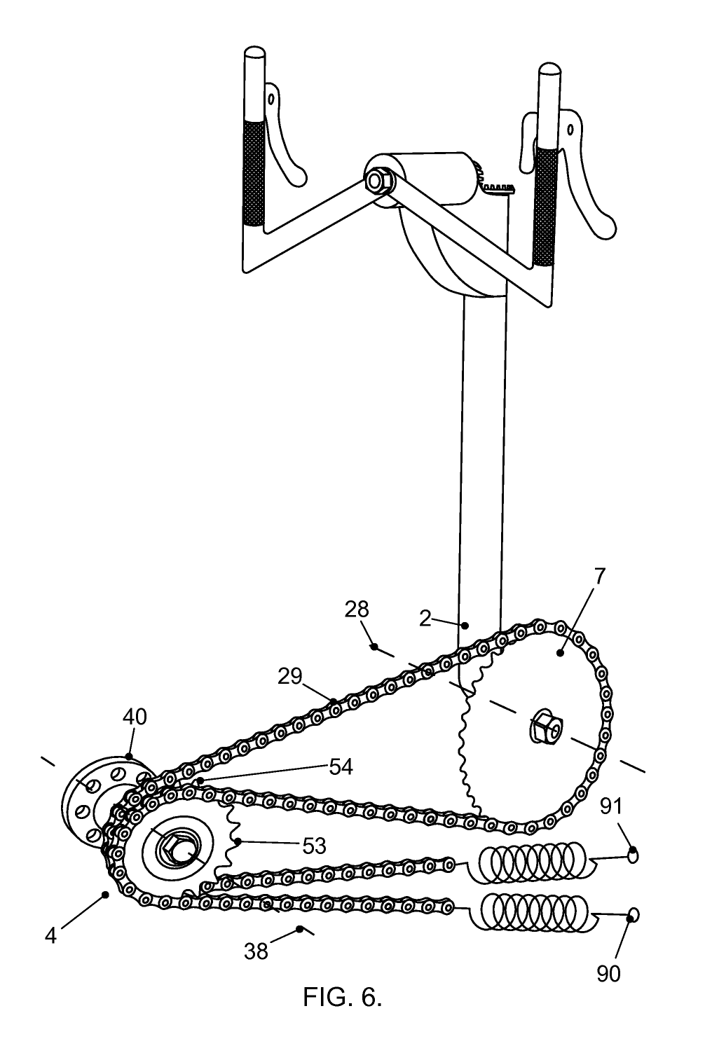

Variation 3). employs a single driving chain-wheel (7) with the drive chain (29) rendered discontinuous and tensioned by springs (90&91) or a suitable length(s) of bungee strapping/elasticated rope/cord. Chain, belt or cord could be used for the flexible member. See FIG. 6.

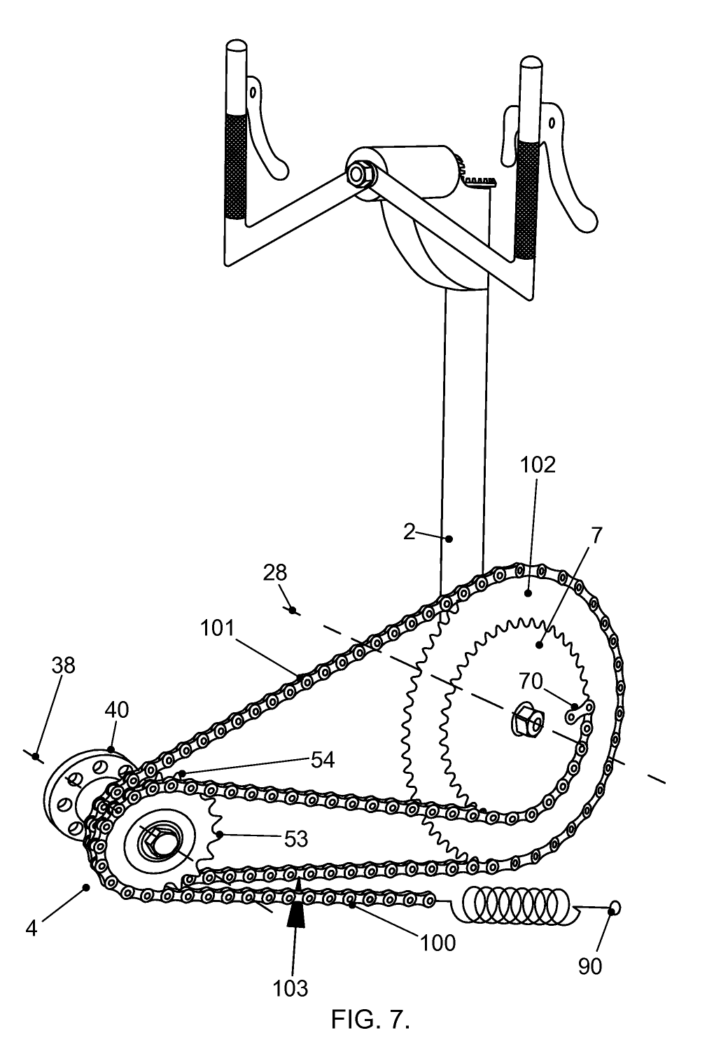

Variation 4). employs dual side by side driving chain-wheels (7&102) utilizing differing tooth numbers apiece. With the discontinuous drive chain (100) being attached to the driving chain-wheel (7) by a spring link (70) and tensioned by a spring (90), and a continuous (or made discontinuous as in FIG. 4.) drive chain (101) operating on the driver and driven chain-wheels (102&54) and tensioned by an adjustment which increases or decreases the centre distance between the driver and driven chain-wheel axes (28&38); or employing an adjustable or spring loaded jockey wheel with its' line of action and location shown by the arrow (103) or a combination of both systems. This enables better chain alignment of the driven chain-wheels (7&102) with respect to the two driven ratcheting chain-wheels (53&54). And additionally allows a different gear ratio to be adopted for the push or pull strokes of the cranking lever (2). In this variation it would be an easy matter to use a combination of chain, belt or cord for the flexible member. See FIG. 7.

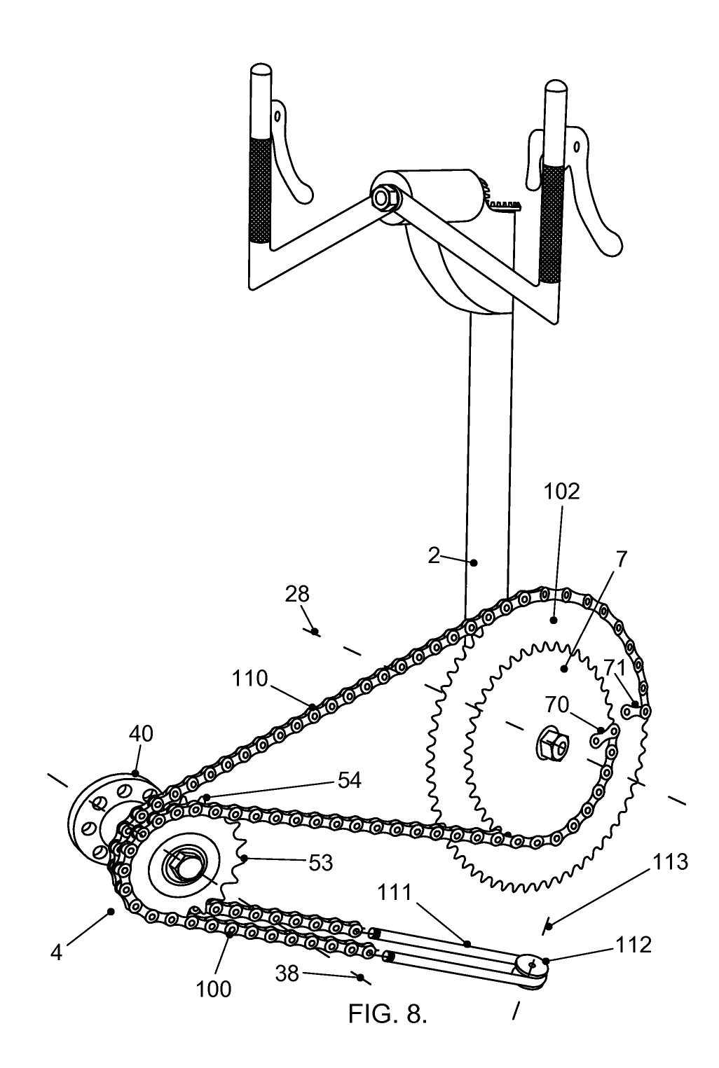

Variation 5). has all the attributes of variation 4). but utilizes discontinuous drive chain (100&110) to operate on the driver and driven chain-wheels (102/54&7/53). Chain tensioning may be accomplished by an adjustable or spring loaded jockey wheel as FIG. 3., or spring(s)/bungee strap(s)/elasticated material as FIG. 6., or the method shown, which utilizes a suitable length of pre-loaded (stretched) bungee strapping (111)/suitable elastic rope/cord/belt material which is guided around an adjustable or spring loaded rotatable jockey wheel bobbin (112) which rotates around an axis (113), the ends of the elasticated material then being attached to each chain end by a suitable method. Note. it would be possible to use a combination of elasticated material and flexible cord to make up item (111); or solely a flexible cord if item (112) were sprung loaded. In this variation it would be an easy matter to use a combination of chain, belt or cord for the flexible member. See FIG. 8.

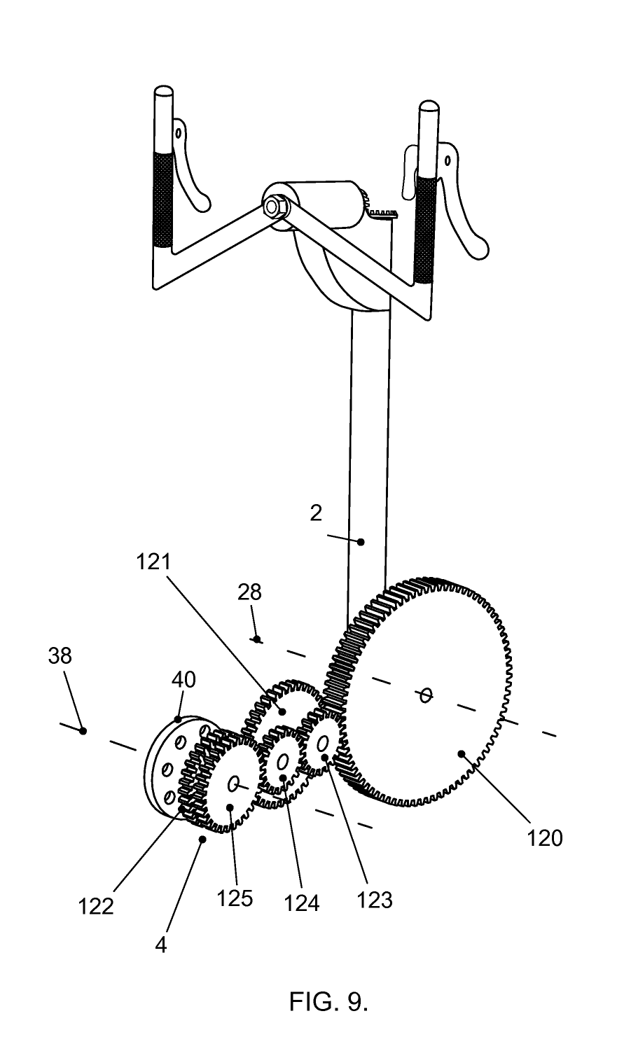

Variation 6). employs a spur gear system to drive the twin ratcheting mechanism, with the cranking lever (2) operated driver gear-wheel (120) driving the first ratcheting gear-wheel via one idler gear-wheel and the second ratcheting gear-wheel via two idler gear-wheels. This enables the driving direction of the driver gear wheel (120) to be reversed and yet drive the ratcheting gear-wheels (122&125) unidirectionally. Thus one ratcheting gear-wheel must always be driven via an idler gear system employing one more or less idler gear-wheel than its' neighbour ratcheting gear-wheel. See FIG. 9.

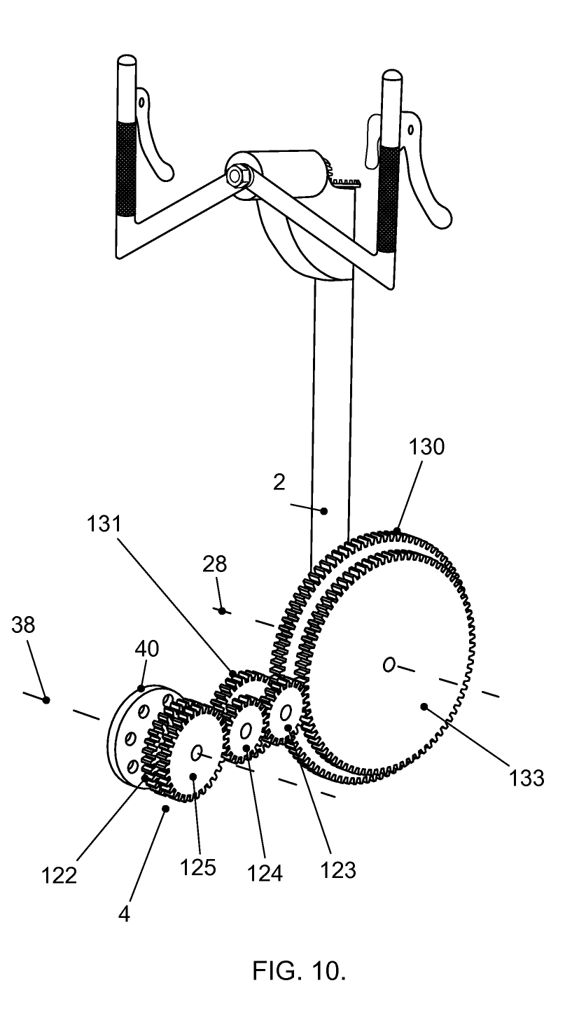

Variation 7). employs a spur gear system as in variation 6). but allows dissimilar gear ratios to be adopted for the push or pull strokes of the cranking lever (2), by the adoption of drive gear- wheels (130&133) of differing tooth numbers. The idler gear- wheel (131) having a different (complimentary) number of teeth to enable correct gear tooth meshing. This arrangement would enable the possibility of dispensing with the single idler gear-wheel (131) and using a single idler gear-wheel in lieu of the twin idler gear-wheels (123&124). See FIG. 10.

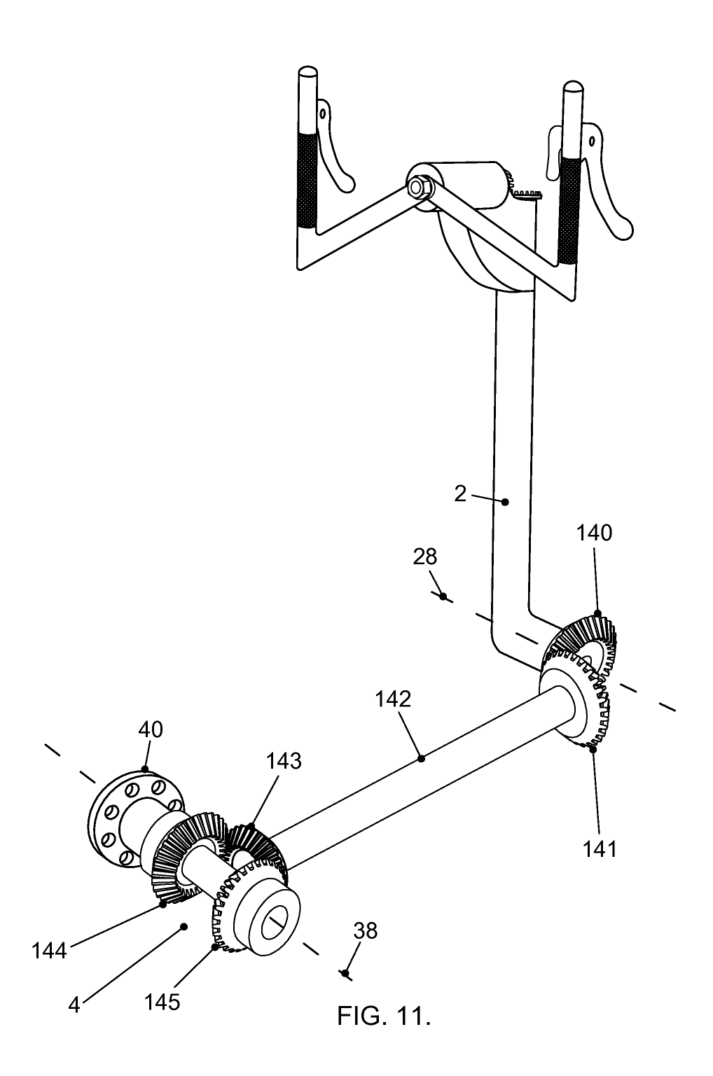

Variation 8). employs a bevel gear-wheel and shaft, gear drive system. The cranking lever (2) rotating a bevel gear set (140&141) which imparts motion via a shaft (142) to a driving bevel gear-wheel (143) which meshes with and alternates the drive to the ratcheting bevel gear-wheels (144&145). See FIG. 11.

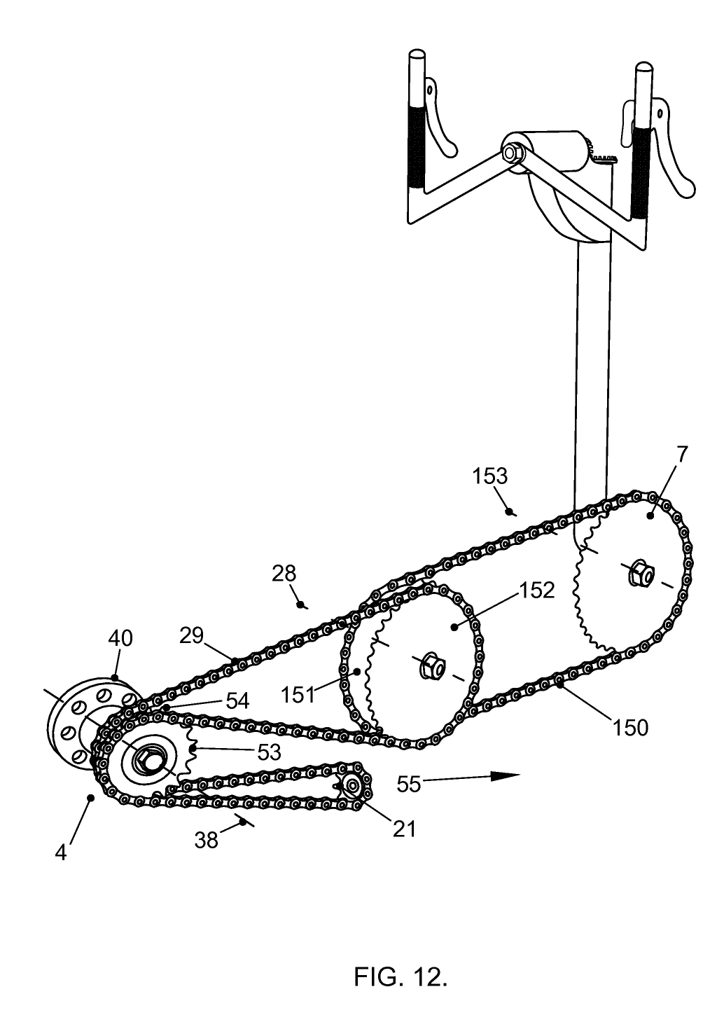

Variation 9). demonstrates how any of the propulsion mechanisms may be remotely driven by the addition of a suitable gear system which is operated by the cranking lever (2). This could be useful if it is wished to adopt shorter chain runs, especially with cycles/vehicles employing a large wheel base. And additionally would enable easy variation of the gear ratio between the cranking lever (2) and the ratcheting chain-wheels (53&54). In this variation, the driving chain-wheel (7) drives an intermediate driven chain-wheel (151) which is positively attached to the driver chain-wheel (152) which in turn drives the ratcheting chain-wheels (53&54) in the usual manner. See FIG. 12.

### Propulsion Mechanism Notes

It should be noted that all the above variations offer different methods of driving the twin ratcheting mechanism, but all have in common that they offer constant proportionality between input and output motion (movement of the riders hands to rotation of the cycle's/vehicle's surface engaging propulsion wheel(s)).

In this embodiment a chain-wheel and roller chain is used to drive the twin ratcheting mechanism (4). But, any of the flexible member driven variations would be able to employ chain, belt or cord or a combination of any of these flexible transmission members.

Several of the variations suggest that differing cranking lever pull/push gear ratios may be arranged by using differing sizes of front driving chain-wheels/gear-wheels/pulley-wheels, however, with the exception of variation number 8, this could also be achieved by employing differing sizes of driven ratcheting chain-wheels/gear-wheels/pulley-wheels etc.

All drive train mechanisms are illustrated as being attached to the driving hub (40), but there is no reason why they should not be attached to the chain-wheel (20), or the hub gear (22) or the surface engaging propulsion wheel(s) (3). And furthermore, iterations of each drive variations may easily be mixed and matched to achieve attributes not directly described and or drawn.

### Free-Wheel Clutch

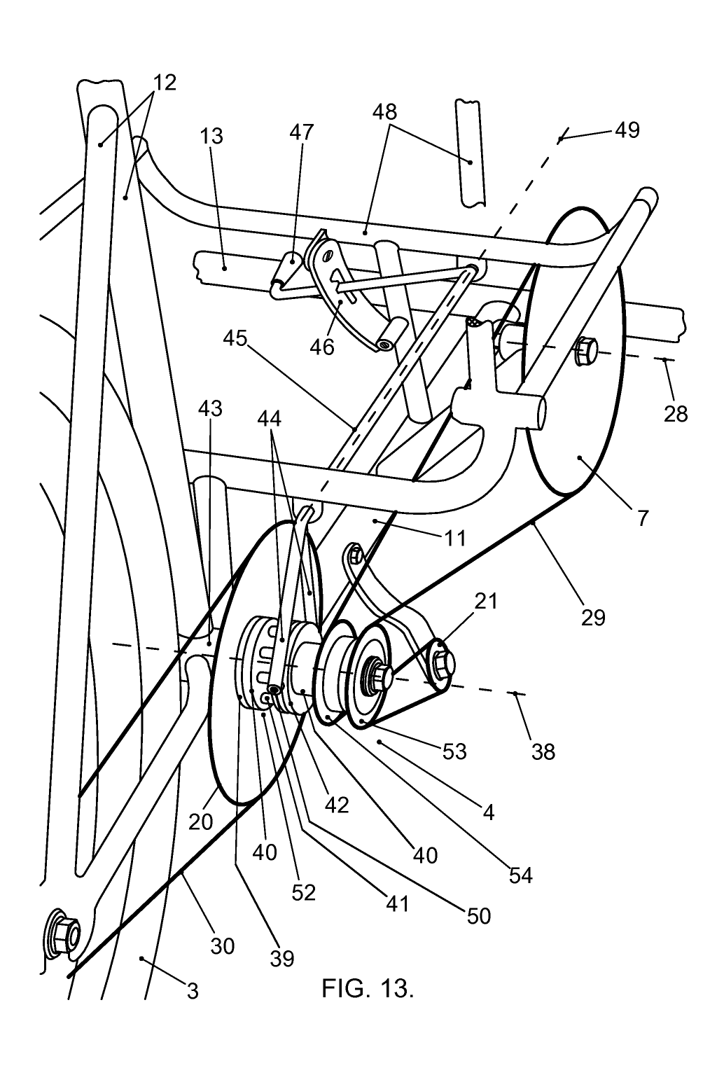

FIGS. 13. to 15. A drive-train clutch (52) is provided which enables the machine to be reversed and or moved (pushed) in either direction via its' surface engaging wheels in isolation to the propulsion mechanism. In operation said drive-train clutch (52) disengages/engages the drive between the ratcheting chain-wheels (53&54) and the intermediate chain-wheel (20). To disengage the drive, a hand lever (47) is moved to the lower notch position of a selector gate (46) which in turn swings a bell crank lever (44) around an axis (49) via a torsion rod (45) away from the intermediate chain-wheel (20). The two bell crank lever selector pins (50) which are permanently engaged with a groove in the sliding pin retaining hub (42) cause said hub (42) and its' driving pins (41) to move out of engagement with the holes (51) of the intermediate chain-wheel hub (39). To engage the drive, said hand lever (47) is moved to the upper notch position of said gate (46) which swings said bell crank lever (44), via said torsion rod (45), towards said intermediate chain-wheel (20). Thus the two bell crank lever selector pins (50) which are permanently engaged with said groove in said sliding pin retaining hub (42), cause said hub (42) and said driving pins (41) which are already engaged with holes (51) of driving hub (40), to move into engagement with said holes (51) of said intermediate chain-wheel hub (39).

### Steering

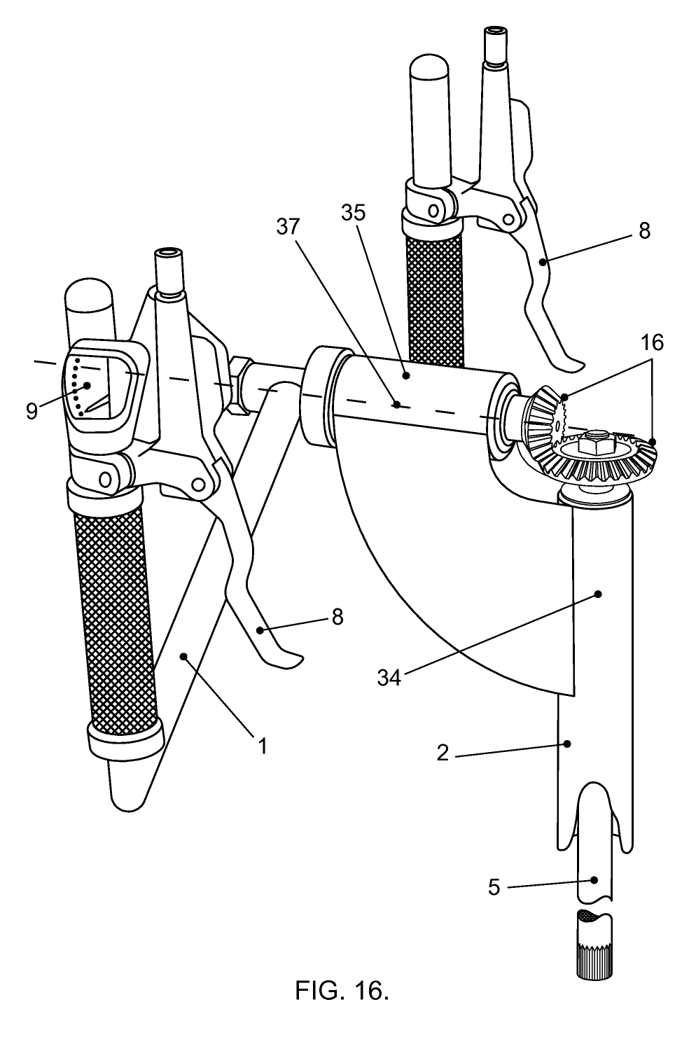

FIGS. 16. & 17. Steering is accomplished by turning a set of handlebars (1) which revolve around a longitudinal axis (37) and are attached to the first bevel gear-wheel of a bevel gear set (16). The bevel gear set (16) revolves in two bearing units (34&35) and transmits the turning force through a right angle to a torsion rod (5) which runs down inside a cranking lever (2) which in this case comprises a metal tube, and is articulated by a universal/constant velocity joint (6) which has its' pivoting bearings/axis set coaxial with the front chain-wheel (7) and its' spindle. The portion of the torsion rod below the universal/constant velocity joint runs through a bush in the longitudinal chassis member (11) and protrudes underneath it. A rear steering arm (17), mounted on its' lower end transmits linear force via a drag link (18) to a front steering arm (25) which is mounted on the right hand kingpin. This in turn steers the right front wheel. A tracking arm (26), also mounted on the right hand kingpin transmits linear force via a tracking rod (19) to a left tracking arm (27) which is mounted on the left hand kingpin. This then steers the left front wheel. Thus both front wheels (15) are kept pointing in the same direction by the tracking arm (19).

### Coaxial Propulsion & Steering

FIGS. 1., 2., 3., 16. & 17. The said universal/constant velocity joint (6) operates around the same axis (28) as the front chain-wheel (7) and its' spindle, and allows the steering torsion rod (5) to operate smoothly while the cranking lever (2) it is situated in, is worked back and forth (32).

### Brakes

FIGS. 1. & 16. Hydraulic disc brakes (33) on all wheels are operated by levers (8) on the handlebars. These are linked together mechanically via a rod so that both brake levers (8) can be operated simultaneously by one hand, or by both hands. A junction box distributes hydraulic pressure equally between the brakes.

### Seat

FIGS. 1. & 2. A frame mounted on the chassis carries a seat (23) and backrest composed of breathable outdoor fabric stretched between the seat frame members.

### Footrests

FIGS. 1. & 2. Footrests (24) are mounted on the crossbeam member (13).

We claim:

1. A human powered cycle/vehicle comprising;
a cranking lever which is caused to reciprocate about an axis;
at least one circular drive member connected to said cranking lever thereby undergoing reciprocal rotational motion driven by the cranking lever;
two circular driven members mounted on a common output shaft by means of respective ratchet devices such that the driven members drive the shaft when rotated in a first direction and free-wheel on the shaft when rotated in a second direction, and;
first and second flexible transmission member portions with at least one portion having a proximal end driven by the drive member and a distal end, wherein the said at least one flexible transmission member portion engages a driven member at a point intermediate its proximal and distal end, the distal ends being connected to a tensioning device, wherein the flexible drive members engage respective driven members such that rotation of the drive member in either direction drives the respective driven members in opposite rotational directions.

2. A human powered cycle/vehicle as claimed in claim 1 wherein said first and second flexible transmission member portions comprise chain or belt or cord or a combination of chain or belt or cord.

3. A human powered cycle/vehicle as claimed in claim 1 wherein said flexible transmission member portions are tensioned by looping said distal ends over a fixed or adjustable or spring-loaded rotatable circular tensioning member.

4. A human powered cycle/vehicle as claimed in claim 1 wherein said flexible member portions are tensioned by connecting said distal ends to a preloaded elasticated flexible tensioning member wherein said preloaded elasticated flexible tensioning member is looped over a fixed or adjustable or spring-loaded rotatable circular tensioning member.

5. A human powered cycle/vehicle as claimed in claim 1 wherein said flexible member portions are tensioned by connecting said distal ends to a preloaded elasticated flexible tensioning member.

6. A human powered cycle/vehicle as claimed in claim 1 wherein at least one flexible transmission member portion is looped over a fixed or adjustable or spring-loaded rotatable circular tensioning member.

7. A human powered cycle/vehicle as claimed in claim 1 wherein at least one flexible transmission member portion is looped over a fixed or adjustable or spring-loaded rotatable circular tensioning member;
and or is tensioned or adjusted by moving the drive member axis of rotation with respect to the driven member axis or rotation.

8. A human powered cycle/vehicle comprising;
a cranking lever which is caused to reciprocate about an axis;
a drive gear connected to said cranking lever thereby undergoing reciprocal rotational motion driven by the cranking lever;
two driven bevel gears mounted on a common output shaft by means of respective ratchet devices such that the driven members drive the shaft when rotated in a first direction and free-wheel on the shaft when rotated in a second direction;
a transmission shaft having a proximal end gear driven by the drive member and a distal end bevel gear engaging respective driven bevel gears such that rotation of the drive gear in either direction drives the respective driven bevel gears in opposite rotational directions.

9. A human powered cycle/vehicle comprising;
a cranking lever which is caused to reciprocate about an axis;
a drive gear connected to said cranking lever thereby undergoing reciprocal rotational motion driven by the cranking lever;
two driven gears mounted on a common output shaft by means of respective ratchet devices such that the driven members drive the shaft when rotated in a first direction and free-wheel on the shaft when rotated in a second direction;
a first transmission gear train comprising at least one gear wheel connecting a drive gear and a first driven gear, and;
a second transmission gear train comprising a number of gear wheels differing by one from that of the first transmission gear train and connecting a drive gear and a second driven gear such that rotation of the drive gear in either direction drives the respective driven gears in opposite rotational directions.

10. A human powered cycle/vehicle as claimed in claim 1 or 8 or 9 in which said common output shaft is connected to a surface engaging propulsive wheel or wheels for the purposes of propelling said cycle/vehicle over a surface.

11. A human powered cycle/vehicle as claimed in claim 10 wherein a clutch is used to propulsively engage or disengage said common output shaft/propulsion mechanism with respect to said surface engaging propulsive wheel(s).

12. A human powered cycle/vehicle as claimed in claim 10 wherein handlebars are attached to said cranking lever.

13. A human powered cycle/vehicle as claimed in claim 12 in which clockwise rotation of said handlebars provides cycle/vehicle steering to the right via a gear and linkage system, and anticlockwise motion of said handlebars provides cycle/vehicle steering to the left via said gear and linkage system.

14. A human powered cycle/vehicle as claimed in claim 13 in which said gear system turns a torsion rod clockwise/anticlockwise via said handlebars.

15. A human powered cycle/vehicle as claimed in claim 14 in which said torsion rod comprises shafting coupled by a universal joint or constant velocity joint.

16. A human powered cycle/vehicle as claimed in claim 15 in which a first portion of said shafting is housed by said cranking lever or an attachment thereto.

17. A human powered cycle/vehicle as claimed in claim 16 in which said universal joint or constant velocity joint works about said cranking lever reciprocal axis of motion.

18. A human powered cycle/vehicle as claimed in claim 17 in which said universal joint or constant velocity joint enables angular movement between said first portion of said shafting and said second portion of said shafting, thus allowing said handlebars to move said cranking lever in a reciprocal motion about said axis of motion, for the purpose of propelling said cycle/vehicle over a surface.

19. A human powered cycle/vehicle as claimed in claim 18 in which said second portion of said shafting is housed by the cycle/vehicle's chassis or an attachment thereto.

20. A human powered cycle/vehicle as claimed in claim 19 in which said shafting steers a steerable wheel or wheels via said linkage system.
